(19) United States
(12) Patent Application Publication
(10) Pub. No.: US 2018/0322452 A1
(43) Pub. Date: Nov. 8, 2018

(54) CENTRALIZED MONITORING AND COORDINATION OF MERCHANDISE TRANSPORTATION USING SHIPPING CONTAINERS

(71) Applicant: Walmart Apollo, LLC, Bentonville, AR (US)

(72) Inventors: Andrew B. Millhouse, Gilbert, AZ (US); Chad Smithpeters, Anchorage, AK (US); Kresimir Jambresic, Centerton, AR (US)

(73) Assignee: Walmart Apollo, LLC, Bentonville, AR (US)

(21) Appl. No.: 15/970,301

(22) Filed: May 3, 2018

Related U.S. Application Data
(60) Provisional application No. 62/500,715, filed on May 3, 2017.

(51) Int. Cl. G06Q 10/08; B65D 81/18

(52) U.S. Cl. CPC G06Q 10/0832; G06Q 10/0833; B65D 81/18; G06Q 10/0831; G06Q 10/08355

(57) ABSTRACT

Systems, methods, and computer-readable storage mediums for coordinating, monitoring, and transporting merchandise are provided to ensure that a retail business can replenish merchandise fast. An example system can include a database for storing merchandise information and a server for maintaining an online dashboard configured to place and track delivery of merchandise orders. The server is also configured to receive merchandise delivery information, associating merchandise with a delivery location, and shipping container information, associating the merchandise with shipping containers. Based on the received information, the server schedules the shipping containers for delivery from a shipping location to the delivery location. Further, the server determines whether a temperature inside the shipping containers is within a predetermined range during their transportation. If not, the server can initiate a remedial procedure directed to replenish the merchandise at the delivery location and estimate an anticipated delivery time of the merchandise to the delivery location.

### BACKGROUND

### 1. Technical Field

The present disclosure relates to methods for planning, routing, and implementing transportation of goods, merchandise, inventory, or other cargo. More specifically, the present disclosure relates to a system and a method for centralized monitoring and coordinating transportation of cargo using, for example, intermodal shipping containers.

### 2. Introduction

Tracking and routing of shipping containers as they travel from one remote shipping location to a purchaser is an important, yet complex task. Typically, when a business purchases inventory or equipment from an overseas company, the purchased goods are transported in one or more intermodal shipping containers through a number of intermediate locations and often using a plurality of different carriers. It is an important task to ensure cost efficiency of cargo transportation in this scenario. It is especially relevant when one shipping container is used to carry several goods ordered by different businesses. It is also relevant when transported goods include perishable merchandise that requires rigid temperature environment and fast delivery.

For businesses that include multiple business locations, such as a large number of retail stores or warehouses, tracking and routing shipping containers, containing purchased merchandise, is often a manual process. For example, a logistics expert may use spreadsheets, email communications, and shipping companies' applications to optimally load and route shipping containers to meet certain business deadlines, while taking into consideration shipment method variables. When the shipping containers are transported by more than one carrier, the logistics become even more complicated. Obviously, the existing methods are inefficient and vulnerable to errors, which can cause increased transportation costs and missed delivery deadlines. Moreover, when businesses do not replenish goods at their retail stores when needed, they can experience lost revenues and decreased customer satisfaction.

### SUMMARY

Disclosed herein are systems, methods, and computer-readable storage mediums for coordinating, monitoring, and transporting merchandise, which overcome at least some drawbacks known in the art. An example method can include: receiving merchandise delivery information, associating ordered merchandise with a delivery location, and storing the merchandise delivery information to the database; receiving shipping container information, associating the ordered merchandise with at least one shipping container, and storing the merchandise delivery information to the database; based on the merchandise delivery information and the shipping container information, scheduling said at least one shipping container for delivery from a shipping location to the delivery location by at least one carrier; determining whether a temperature inside said at least one shipping container is within a predetermined range; if it is determined that the temperature inside said at least one shipping container is within the predetermined range, monitoring transportation of said at least one shipping container from the shipping location to the delivery location by said at least one carrier and, based at least in part on the monitoring, estimating a first delivery time of the ordered merchandise to the delivery location, wherein the database is updated with the first delivery time of the ordered merchandise; and if it is determined that the temperature inside said at least one shipping container is not within the predetermined range, initiating a remedial procedure directed to replenish the ordered merchandise at the delivery location and, based at least in part on the remedial measure, estimating a second delivery time of the ordered merchandise to the delivery location, wherein the database is updated with the second delivery time of the ordered merchandise.

An example system for performing the method can include a database and a server for maintaining an online dashboard accessible by users, wherein the online dashboard is configured to place and monitor delivery of merchandise orders, wherein the server is configured to: receive merchandise delivery information, associating ordered merchandise with a delivery location, and store the merchandise delivery information to the database; receive shipping container information, associating the ordered merchandise with at least one shipping container, and store the merchandise delivery information to the database; based on the merchandise delivery information and the shipping container information, schedule said at least one shipping container for delivery from a shipping location to the delivery location by at least one carrier; determine whether a temperature inside said at least one shipping container is within a predetermined range; if it is determined that the temperature inside said at least one shipping container is within the predetermined range, monitor transportation of said at least one shipping container from the shipping location to the delivery location by said at least one carrier and, based at least in part on the monitoring, estimate a first delivery time of the ordered merchandise to the delivery location, wherein the database is updated with the first delivery time of the ordered merchandise; and if it is determined that the temperature inside said at least one shipping container is not within the predetermined range, initiate a remedial procedure directed to replenish the ordered merchandise at the delivery location and, based at least in part on the remedial measure, estimate a second delivery time of the ordered merchandise to the delivery location, wherein the database is updated with the second delivery time of the ordered merchandise.

An example non-transitory processor-readable storage medium can have instructions stored thereon, which when executed by one or more processors, cause the one or more processors to implement a method, comprising: receiving merchandise delivery information, associating ordered merchandise with a delivery location, and storing the merchandise delivery information to the database; receiving shipping container information, associating the ordered merchandise with at least one shipping container, and storing the merchandise delivery information to the database; based on the merchandise delivery information and the shipping container information, scheduling said at least one shipping container for delivery from a shipping location to the delivery location by at least one carrier; determining whether a temperature inside said at least one shipping container is within a predetermined range; if it is determined that the temperature inside said at least one shipping container is within the predetermined range, monitoring transportation of said at least one shipping container from the shipping location to the delivery location by said at least one carrier and, based at least in part on the monitoring, estimating a first delivery time of the ordered merchandise to the delivery location, wherein the database is updated with the first delivery time of the ordered merchandise; and if it is determined that the temperature inside said at least one shipping container is not within the predetermined range, initiating a remedial procedure directed to replenish the ordered merchandise at the delivery location and, based at least in part on the remedial measure, estimating a second delivery time of the ordered merchandise to the delivery location, wherein the database is updated with the second delivery time of the ordered merchandise.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Embodiments of this disclosure are illustrated by way of an example and not limitation in the figures of the accompanying drawings, in which like references indicate similar elements and in which:

FIG. 1 illustrates a simplified geographic map showing a plurality of delivery locations and a plurality of shipping locations;

FIG. 2 illustrates an example computer system environment for practicing methods for coordinating, monitoring, and transporting merchandise;

FIG. 3 illustrates a process flow diagram showing an example method for coordinating, monitoring, and transporting merchandise according to one embodiment; and

FIG. 4 illustrates an example computer system which can be used to implement the methods for method for coordinating, monitoring, and transporting merchandise.

### DETAILED DESCRIPTION

Various configurations and embodiments of the disclosure are described in detail below. While specific implementations are described, it should be understood that this is done for illustration purposes only. Other components and configurations may be used without parting from the spirit and scope of the disclosure.

The concepts and embodiments described herein are provided to overcome at least some drawbacks known in the art and are directed to facilitate transportation of goods to retail stores or other businesses using shipping containers such as intermodal shipping containers. The embodiments of this disclosure also provide methods and rules to improve efficiency of monitoring and coordinating merchandise transportation. The methods may include low or no manual involvement.

Accordingly, this disclosure concerns a system and method for centralized monitoring and coordinating of merchandise transportation from one location to another location by one or more carriers. The system may employ an online platform, online “dashboard,” or a web service which can be accessed by personnel of businesses ordered transportation of merchandise. The system is also designed to automatically pull different data concerning ordered merchandise, shipment data (including shipment conditions, temperature measurements, etc.), transportation data, or routing data from multiple locations according to a set of rules and upload them to a database. The database can be an online database or “cloud” database meaning certain or all information stored in the database can be available to remote computing devices via a communications network or the Internet. In certain embodiments, there can be provided multiple databases to implement the same functions.

Based on the aggregated data in the database, the system can automatically generate and offer one or more optimal routing solutions to transport certain merchandise from a shipping location to a business location (also referred herein to as “delivery location” in some embodiments). The personnel of business location or other operators, such as logistics experts, can review offered routing solutions and approve or modified them. In some implementations, the routing solutions can be modified or approved by the system automatically based on predetermined rules. Once approved, the routing solutions are sent by the system to one or more carriers to execute a transportation function. In addition, the system can automatically generate and transmit certain documents such as a bill of lading (BOL) or documents with load information or load requirements. Also, the system can automatically monitor the transportation process and periodically send updates to business personnel to inform about anticipated delivery dates so that they could schedule their labor appropriately.

Notably, the system can also employ rules based on a plurality factors, variables, or parameters, including, for example, required delivery dates to business locations, planned ship loading windows, and pre-booking load data. In addition, the system can be configured to create and save templates of shipments by date. The templates can be later used to simplify the routing and transportation coordinating steps. For example, a template created for the second week of September 2017 could be reused for the second week of September 2018 by applying an appropriate weighting factor. The templates can be also automatically modified by the system upon recently collected data updated to the database. Based on data updates, the system can adjust weighting factors in the templates to reflect current logistics conditions.

Moreover, in some implementations, the rules can be organized in a manner to better accommodate to the real-world logistics environment. In one example, the rules may automatically allow excess shipping containers booked on an ocean carrier departing on a certain date to be held for the next sailing depending on merchandise type (perishable or non-perishable). In another example, the rules of the system may automatically re-prioritize shipping of certain shipping containers or assets based on a number of factors, such as condition of goods, transportation or storage conditions, and the like. Yet in additional implementations, the system can determine inventory levels of certain goods at retail stores and prioritize shipping of certain shipping containers carrying those goods that needed to be replenished as their inventory levels became low.

The following provides an overview example process for merchandise transportation according to various embodiments of this disclosure.

Initially, the system may generate, receive and/or store merchandise delivery information and shipping container information to the database. The merchandise delivery information can include merchandise data (e.g., merchandise identification), a delivery location (e.g., a business location that ordered or purchased the merchandise), and optionally a lead time of the merchandise. In some embodiments, the merchandise delivery information can refer to a purchase order originated by a business location. The shipping container information can refer to data which designates at least one shipping container to carry the ordered merchandise. The shipping container information can be generated automatically based on predetermined rules or retrieved from a template. A shipping container may be assigned based on the size of the order, the size of the container and the availability of the container. Before or after the receipt of the merchandise delivery information and shipping container information, the merchandise can be loaded to shipping containers.

Further, the system automatically schedules the shipping container (or a plurality of shipping containers) for delivery from a shipping location (e.g., a supplier) to the delivery location (e.g., the business location that ordered or purchased the merchandise) by at least one carrier (e.g., an ocean carrier). The scheduling process can be based on the merchandise delivery information and the shipping container information. In some embodiments, the scheduling process can involve generating one or more suggested routes, retrieving one or more templates containing routes, or modifying one or more templates containing routes. In yet other embodiments, the scheduling process can also involve estimating an anticipated delivery date of the merchandise to the delivery location. The suggested routes and/or the anticipated delivery date can be sent to personnel of the delivery location, logistics experts, representatives of the carrier, and the like.

Once the shipping containers are loaded with the merchandise, the system can monitor various parameters regarding the shipment and its location. When the parameters do not meet desired criteria the system can take corrective action, for example based on a set of rules. Exemplary parameters that may be monitored include a temperature regime inside the shipping containers and determine whether or not the temperature is within a predetermined range or over than a predetermined value. In other embodiments, other parameters, such as a moisture level or an impact level, can be also measured and monitored. The location of the container and an estimated delivery date may also be tracked. Damage to the container may also be detected.

The sensors in the containers may store and forward data, such as temperature, periodically. To save power, the sensor may monitor temperature periodically, but only send the data in bursts. To enable greater transaction processing by the system, the system may send temperature data which exceeds a threshold more frequently, but for temperatures within specifications, the system may transmit these using a longer period between transmissions. The sensors may be equipped with transmitters, for example using 2G and 3G wireless bands as well as WIFI. While onboard ship, the sensors may communicate with a WIFI receiver connected to a satellite transmitter to provide data to a central computer system. This makes the computer system and network more efficient by reducing network traffic and freeing up the system to handle other tasks more expediently.

If it is determined that the temperature inside at least one of the shipping containers is within the predetermined range, the system merely monitors the transportation process and calculates or updates the estimated delivery time of the merchandise. Otherwise, if it is determined that the temperature inside at least one of the shipping containers is not within the predetermined range, the system initiates a remedial procedure directed to replenish the merchandise at the delivery location as soon as practicable. The system continues monitoring the transportation process and calculates or updates the estimated delivery time of the merchandise in view of the remedial procedure. The remedial procedure can depend on a condition of merchandise. In some embodiments, the remedial procedure can be based on determination of how long the temperature inside at least one of the shipping containers was not within the predetermined range. If this time frame is less than a predetermined value for one of the shipping containers, the remedial measure can involve searching for a second shipping container on board of the same carrier which carries the same merchandise; and, once found, the system can re-schedule or re-prioritize transportation of the second shipping container. If this time frame is more than a predetermined value for one of the shipping containers, the remedial measure can involve searching for merchandise that is the same or similar to the one contained in the shipping container having problems with a temperature regime. When located, same or similar merchandise from other business locations can be caused to be transported to the business location which requires replenish of the ordered merchandise.

It can also be determined if the carrier is on time with the delivery of the container. If not, the system may initiate remedial measures based on a set of rules. If the delay is greater than a selected time, the system can identify those products in the container that is delayed. The can determine if the retail stores in the area for the intended delivery have the items available, for example excess stock. If so, the system can instruct the carrier to transfer the items from the stores with enough inventory to those that may be low or out of items due to the delay. If there are no such stores, the delivery location is updated with the location and ETA of the container so the location may plan accordingly.

Once a ship carrying the container arrives at port the containers may be re-prioritized based the delivery location in-stock rating. Those container with items destined for locations with higher need for the items may be given a higher priority. The various database are updated with current information and the delivery locations may be provided with the current location of the container and an ETA.

Thus, the system is configured intelligently monitor various information concerning transportation of shipping containers and delivery of ordered merchandise to business locations such that the system becomes a centralized solution. The system enables to automatically provide optimal routes for delivery of shipping containers based on aggregated information, automatically notify all relevant individuals about estimated delivery times, and track the transportation process. In case certain issues are detected with the transportation process, the system can automatically implement one or more remedial measures.

For purposes of this disclosure, the terms “retail store,” “business,” “business location,” and “delivery location” can be used interchangeably and shall be construed to mean an organization that stores goods or sells goods to one or more buyers or customers. Some examples of “business” can include, but not limited to, a retail store, a retailer, a market, a supermarket, a wholesale merchant, a distributor, a dealership, and so forth. Furthermore, for purposes of this disclosure, the terms “goods,” “merchandise,” “inventory,” “assets,” and “cargo” can be used interchangeably and shall be construed to mean tangible products or commodity that can be a subject for of storage or sale from a business to a customer. Examples of merchandise include, but not limited to, foods, drinks, apparel, toys, electronics, and the like. Accordingly, merchandise can include perishable and non-perishable items.

The term “shipping container” shall be construed to mean a container, a box, a tankage, a reservoir, a crate, a drum, a pail, a unit load device, a storage assembly, a packaging, or any other device or system suitable for shipping, transporting, storing, and handling certain merchandise items. One example of shipping container is an intermodal shipping container or an intermodal freight container. The term “carrier” shall be construed to mean an individual, an organization, or an entity that transport shipping containers from one location to another location. The term “carrier” can be also construed to mean a transportation means for transporting shipping containers. Thus, some examples of carriers can include ocean carriers, ships, trucks, trains, airplanes, or other vehicles, including driverless vehicles. In some embodiments, the terms “shipping,” “shipment,” “transporting,” and “transportation” can be used interchangeably and mean a process of relocating certain items from one location to another. The terms “scheduling,” “planning,” and “routing” can also be used interchangeably and may be construed to mean a process for determining a route from an shipping location (origin) to a delivery location (destination), calculating route from an origin to a destination, selecting a route from an origin to a destination, suggesting one or more routes from an origin to a destination, or determining (calculating) a load of merchandise in one or more shipping containers.

The term “notification” shall be construed to mean an electronic message (e.g., an email, text message, or push notification) or a signal bearing certain information. The terms “or” and “and” shall mean “and/or” unless stated otherwise or clearly intended otherwise by the context of their use. The term “a” shall mean “one or more” unless stated otherwise or where the use of “one or more” is clearly inappropriate.

Various embodiments, implementations, and examples will be further described as the illustrations of the disclosure are described in detail below. While specific implementations are described, it should be understood that this is done for illustration purposes only. Other components and configurations may be used without parting from the spirit and scope of the disclosure. In addition, components, steps, and features described may be removed, added, or combined from the provided examples.

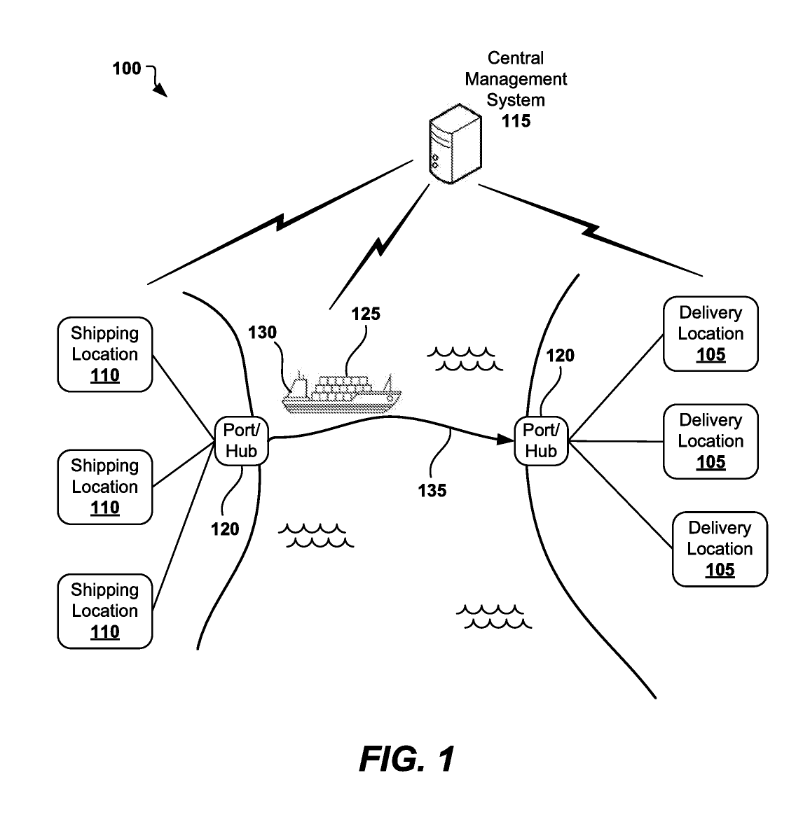

FIG. 1 illustrates a simplified geographic map 100 showing a plurality of delivery locations 105 (e.g., retail stores) and a plurality of shipping locations 110 (e.g., suppliers, vendors) according to one example embodiment. Geographic map 100 shown in FIG. 1 can be a displayed via a graphical user interface of a computing device to operators of centralized management system 115 discussed below. Geographic map 100 also illustrates certain shipping points 120 such as ports, warehouses, transportation hubs, and the like. Shipping containers 125, such as intermodal freight containers, are shipped from one or more of shipping locations 110 to one or more of delivery locations 105 by at least one carrier 130 (e.g., a ship, ocean carrier, train, truck, and the like). The transportation of shipping containers 125 is performed in accordance with at least one route 135 which can be automatically generated or suggested by centralized management system 115.

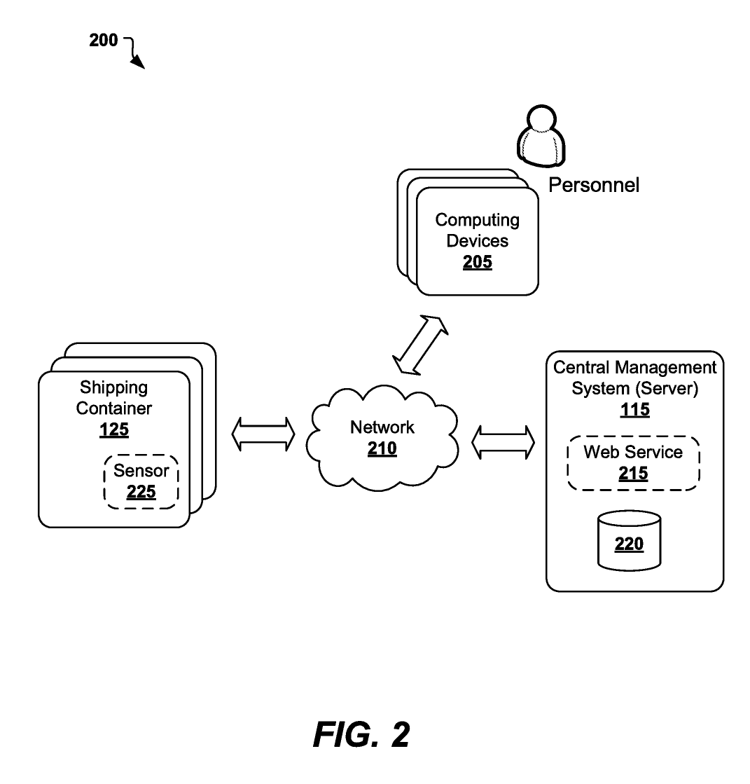

FIG. 2 illustrates an example computer system environment 200 for practicing the methods for coordinating, monitoring, and transporting merchandise according to one example embodiment. As shown in the figure, computer system environment 200 includes centralized management system 115, which is executed as a server or similar computing device. Centralized management system 115 is in communication with computing devices 205 operated by personnel of delivery locations, personnel of carriers, logistics professionals, and so forth via a communications network 210. Communications network 210 can refer to any wired, wireless, or optical network. For example, communications network 210 can include the Internet.

Centralized management system 115 can employ a web service 215 to exchange data with computing devices 205. In some implementations, web service 215 can additionally include or refer to a web page, web site, an online platform, or an online dashboard. Accordingly, the personnel or other relevant individuals can access or obtain data from centralized management system 115 via a browser installed on their computing devices 205 by visiting a predetermined web site associated with centralized management system 115 or a software application installed on computing devices 205 which can automatically exchange data between centralized management system 115 and computing devices 205.

Computer system environment 200 also includes one or more databases 220 which can be operatively connected to centralized management system 115 via communications network 210 or be incorporated directly into centralized management system 115. Each database 220 can store data associated with merchandise, carriers 130, delivery locations 105, and shipping locations 110. In other words, databases 220 may receive, store, and update information concerning merchandise levels at delivery locations 105, purchased merchandise by delivery locations 105, ordered merchandise by delivery locations 105, shipping containers 125, carriers 130, loads, schedules, booking information, routes, templates, user profiles, and historical data concerning the above-listed information.

Computer system environment 200 also includes one or more sensors 225. The sensors 225 may be near or secured to shipping containers 125. Sensors 225 can be configured to measure certain transportation parameters and send the measured transportation parameters to centralized management system 115 via communications network 210. The transportation parameters can include one or more of the following: a temperature inside shipping container 125, a temperature of merchandise carried by shipping container 125, shock and impact information concerning the merchandise or shipping container 125, a moisture level inside shipping container 125, a current geographical location of shipping container 125, and so forth.

In some instances, the ability to communicate the sensor data to the central system, or to access a database, may be restricted. For example, the container may be in transit when a temperature sensor detects a temperature spike which needs to be recorded. In some configurations, this can be remedied by having a smart seal applied to the package. The smart seal can contain a basic processor, memory, and communications equipment. The smart seal may have power for these computing/communication elements, or the smart seal may be remotely powered (using near field communications, induction, RFID (Radio Frequency Identification), UHF (Ultra High Frequency), etc.). In such configurations, the container thermometer can register the temperature change, then communicate the data to the smart seal. In one example, the smart seal can record the temperature data within the smart seal memory, which can then be communicated to the central system when capable of communicating with a network and the central server. As another example, the smart seal can store a copy of a container's blockchain, compare the sensor data to values stored on the blockchain, and determine if the values are sufficiently different that a new block needs to be generated. If a new block does need to be generated, the smart seal can then generate the new block based on the differences between the current sensor data to previous values, then add that block to the stored blockchain within the smart seal. When the container is within range of a network and the central system, the updated blockchain can be communicated to the central server, where it can replace the stored blockchain for that container with the updated version.

Centralized management system 115 can include at least one processor and at least one memory storing processor-readable instructions which, when executed by the processor, cause centralized management system 115, its components (e.g., the processor), or other elements to perform operations of the methods of coordinating, monitoring, and transporting merchandise as described herein. In certain embodiments, centralized management system 115 can include a web server.

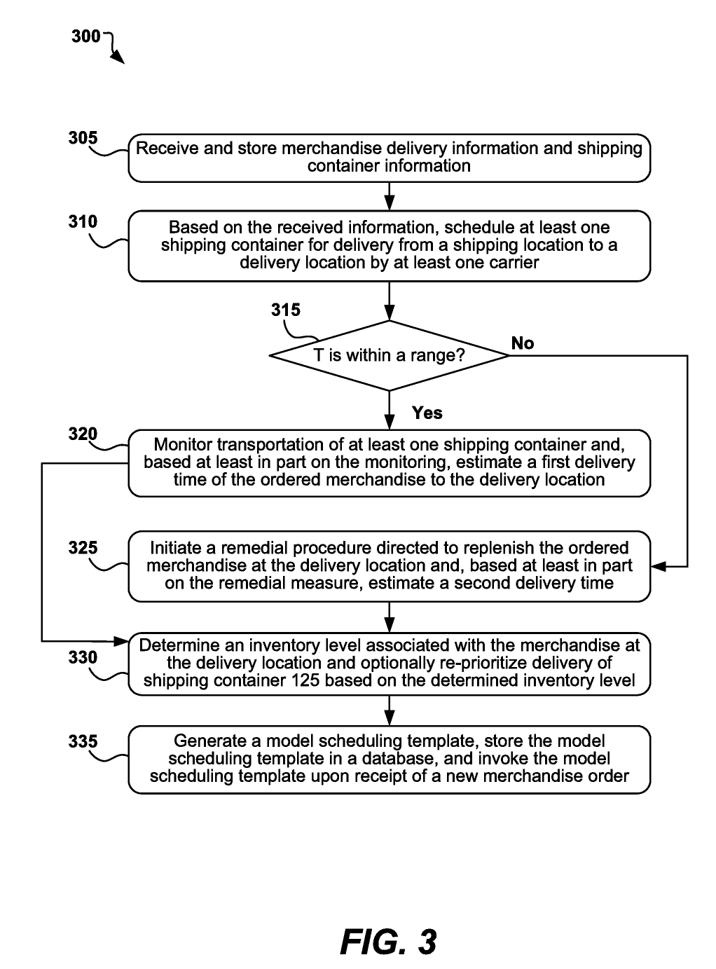

FIG. 3 illustrates a process flow diagram showing an example method 300 for coordinating, monitoring, and transporting merchandise according to one embodiment. Method 300 may be performed by processing logic that may comprise hardware (e.g., decision-making logic, dedicated logic, programmable logic, application-specific integrated circuit, and microcode), software (such as software run on a general-purpose computer system or a dedicated machine), or a combination of both. In one example embodiment, the processing logic refers to centralized management system 115 as described above. Below recited operations of method 300 may be implemented in an order different than described and shown in the figure. Moreover, method 300 may have additional operations not shown herein, but which can be evident for those skilled in the art from the present disclosure. Method 300 may also have fewer operations than outlined below and shown in FIG. 3.

Method 300 commences at operation 305 with centralized management system 115 receiving and storing to database 220 merchandise delivery information and shipping container information. The merchandise delivery information can be received or originated from, for example, one of delivery locations 105. In general, the merchandise delivery information describes merchandise ordered for certain delivery location 105. For example, merchandise delivery information can indicate particular goods, their quantity, lead time (expected delivery time), delivery address, and other related information. The shipping container information, however, can be received from delivery location 105, shipping location 110, shipping point 120, carrier 130, or, in alternative, the shipping container information can be automatically generated by central management system 115. In certain embodiments, the shipping container information can associate the ordered merchandise, for example, as described by the merchandise delivery information, with at least one shipping container 125. For example, the shipping container information can indicate shipping containers' identifications, data concerning loading, planning, booking, or location of at least a specific one(s) shipping container 125 to carry at least a part of the ordered merchandise.

At operation 310, central management system 115 schedules at least one shipping container 125 for delivery from at least one shipping location 110 to at least one delivery location 105 by at least one carrier 130. The scheduling is performed based on the merchandise delivery information, the shipping container information received, and at least one predetermined rule. The predetermined rule can depend on a required delivery date of the ordered merchandise, a planned carrier loading window, load booking information of at least one carrier 130, and other factors. Overall, the scheduling can designate certain parts or entire ordered merchandise with one or more of shipping containers 125, identify when and how shipping containers 125 shall be transported by one or more carriers 130. The scheduling can also include generating one or more routes 135 for one or more carriers 130. The information concerning the routes can be then sent to carriers 130 or other participants. In certain embodiments, at operation 310, central management system 115 can optionally calculate estimated delivery time of the merchandise or shipping containers to delivery locations 105. Furthermore, central management system 115 can optionally send notifications to delivery locations 105, carrier 130, shipping location 110, or other related parties or their representatives or agents. The notifications can include the scheduling information (concerning the process of scheduling at least one shipping container 125 for delivery from at least one shipping location 110 to at least one delivery location 105 by at least one carrier 130), the estimated delivery time, or other relevant information.

At operation 315, central management system 115 determines whether a parameter is within or otherwise meets desired criteria. If not, the system can take action based on a set of rules. Examples of parameters may include the temperature within a container, the location of the container and estimated delivery date/time. In one example, it is determined if the temperature inside said at least one shipping container 125 is within a predetermined range. For these ends, central management system 115 can periodically obtain measurement readings from sensors 225 installed in shipping containers 125. An example predetermined range of temperatures can be, for example, from about −20 F. to about +5 F. In other embodiments, central management system 115 can periodically obtains other information about the container, its contents, and other climate-related information.

If it is determined at operation 315 that the temperature inside said at least one shipping container 125 is within the predetermined range, method 300 proceeds to operation 320 where central management system 115 monitors transportation of at least one shipping container 125 from shipping location 110 to delivery location 105 by at least one carrier 130 and, based at least in part on the monitoring, central management system 115 estimates a first delivery time of the ordered merchandise to delivery location 105. Central management system 115 can further update database 220 with the first delivery time of the ordered merchandise. The monitoring operation can involve tracking current geographical location of at least one shipping container 125 and information measured by sensor 225. The system can determine if there is a delivery delay or the temperature with the container. In addition, central management system 115 can send a notification to delivery location 105 or other parties with the first delivery time of the ordered merchandise.

If it is determined that there is a delay, the system may take remedial action based on the rules described above.

Forward planning for offshore markets is more important because replenishment intervals can be one week or more. The system may include exception handling where if a temperature sensor indicates that a container temperature control has malfunctioned, the container inventory is analyzed for impact. Products out of cold chain compliance may be flagged by the system. The system may query an inventory database of the receiving store and determine how long the existing product will last. Based upon this data, the system may determine if a replacement container can be sent or if air freight must be used for replenishment of the product(s).

The system may monitor data regarding the containers and detect trends in the data, for example by comparing present sensor values with prior sensor values. Automatic alerts may be generated when temperature trends are moving towards the specified cold chain limits. A malfunctioning container temperature control unit can be identified and replacement cargo and shipping method may be identified. For containers which have not yet exceeded the cold chain, the system can offer a closer store for delivery so the goods are delivered before the temperature ranges are exceeded.

In alternative, if it is determined at operation 315 that the temperature inside at least one shipping container 125 is not within the predetermined range (e.g., the temperature is above a predetermined threshold value, such as more than +5 F.), method 300 proceeds to operation 325 where central management system 115 initiates a remedial procedure directed to replenish the ordered merchandise at the delivery location and, based at least in part on the remedial measure, central management system 115 estimates a second delivery time of the ordered merchandise to delivery location 105. Central management system 115 can further update database 220 with the second delivery time of the ordered merchandise. Note that the second delivery time likely differs from the first delivery time. In addition, central management system 115 can send a notification to delivery location 105 or other parties with the second delivery time of the ordered merchandise. The remedial procedure is further described below.

After operations 320 and 325, method 300 may proceed with optional operation 330, as shown in FIG. 3, where central management system 115 periodically determines a current inventory level associated with the merchandise at delivery location 105 and re-prioritizes delivery of at least one shipping container 125 from shipping location 110 to delivery location 105 based on the determined inventory level. For example, if it is determined at operation 330 that the inventory level of certain goods is lower than a predetermined value at particular delivery location 105, the replenishment of these goods should performed faster than scheduled. In this scenario, central management system 115 can automatically re-prioritize shipping and transportation of these goods so as to replenish them at delivery location 105 as fast as possible. In additional implementations, central management system 115 can also determine inventory levels of the same goods at other delivery locations 105 can automatically cause shipping and transportation of the goods from other delivery locations 105 to delivery location 105 where the inventory level dropped below the predetermined value.

At yet additional, but optional, operation 335, central management system 115 generates a model scheduling template associated with the scheduling of at least one shipping container 125 for delivery from shipping location 110 to delivery location 105 by at least one carrier 130, store the model scheduling template in database 220, and invoke the model scheduling template upon receipt of a new merchandise order from the same shipping location 110 to the same delivery location 105. The model scheduling template facilitates subsequent shipments and transportation of same or similar merchandise to delivery locations 105. In some implementations, when the model scheduling template is invoked, central management system 115 modifies it, for example, by applying weight factors based on current parameters of ordered merchandise or other factors.

The remedial procedure of operation 325 can include further operations depending on the temperature readings and information indicating how long the temperature inside certain shipping containers 125 were not within the predetermined range or value. Specifically, the remedial procedure may cause central management system 115 determine whether the temperature inside at least one shipping container 125 not being within the predetermined range is less or greater than a first predetermined period (e.g., 48 hours). If it is determined that the temperature inside at least one shipping container 125 not being within the predetermined range is greater than the first predetermined period (e.g., 48 hours), central management system 115 can perform searching for another shipping container 125′ on board of at least one carrier 130 that contains the same or similar merchandise as in the shipping container with “wrong” temperatures. If another shipping container 125′ on board of the carrier 130 is located, central management system 115 prioritizes delivery of the shipping container 125′ to delivery location 105. In alternative, if another shipping container 125′ on board of carrier 130 is not located, central management system 115 orders replacement merchandise, schedules delivery of the replacement merchandise to delivery location 105, and estimates a third delivery time of the replacement merchandise to delivery location 105. Further, database 220 can be updated with the third delivery time of the replacement merchandise. Central management system 115 can also send a notification to delivery location 105 or other parties to inform about the replacement merchandise and the third delivery time of the replacement merchandise. In addition, central management system 115 can generate and submit a claim with an insurance company or carrier 130.

In case when it is determined that the temperature inside at least one shipping container 125 not being within the predetermined range is less than the first predetermined period (e.g., less than 48 hours), central management system 115 can determine whether the temperature inside said at least one shipping container not being within the predetermined range is less or greater than a second predetermined period. The second predetermined period (e.g., 24 hours) can be less than the first predetermined period (e.g., 48 hours). If it is determined that the temperature inside said at least one shipping container not being within the predetermined range is less than the second predetermined period (e.g., 24 hours), central management system 115 simply re-estimates the first delivery time of the ordered merchandise to delivery location 105 and update database 220 with the first delivery time after said re-estimating. In some implementations, central management system 115 can re-prioritize or facilitate delivery. Central management system 115 can also notify delivery location 105 or other parties with temperature information and the re-estimated first delivery time. If it is determined that the temperature inside at least one shipping container 125 not being within the predetermined range is greater than the second predetermined period (e.g., 24 hours), central management system 115 can identify analogue merchandise at other business location and initiate transportation of the identified analogue merchandise from other business location to delivery location 105.

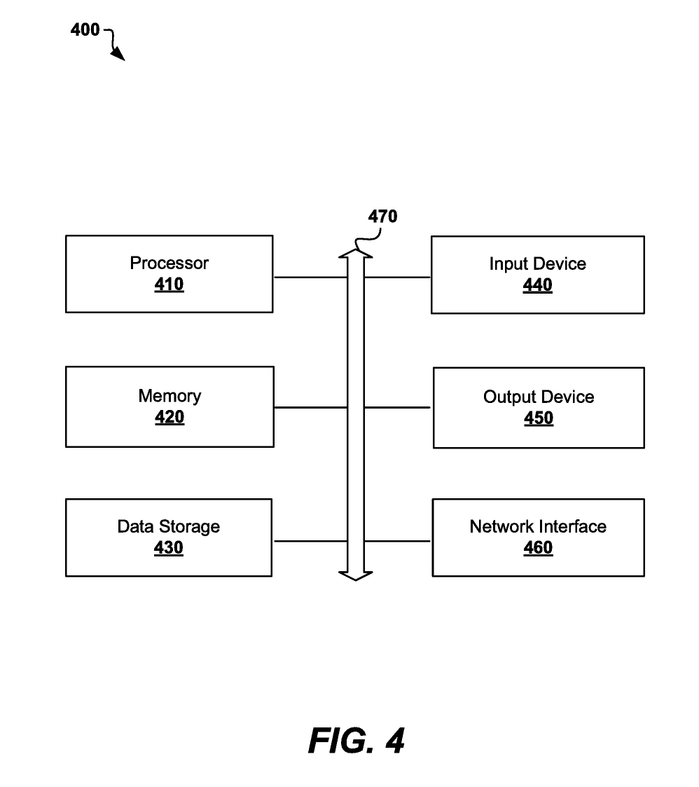

FIG. 4 illustrates an example computer system 400 which can be used to perform the methods for monitoring, coordinating, and transporting merchandise as disclosed herein. Computer system 400 can be an instance of at least one of computing device 205 and centralized management system 115 shown in FIG. 2. With reference to FIG. 4, computing system 400 includes one or more processors 410, one or more memories 420, one or more data storages 430, one or more input devices 440, one or more output devices 450, network interface 460, one or more optional peripheral devices, and a communication bus 470 for operatively interconnecting the above-listed elements. Processors 410 can be configured to implement functionality and/or process instructions for execution within computing system 400. For example, processors 410 may process instructions stored in memory 420 or instructions stored on data storage 430. Such instructions may include components of an operating system or software applications.

Memory 420, according to one example, is configured to store information within computing system 400 during operation. For example, memory 420 can store instructions to perform the methods for monitoring, coordinating, and transporting merchandise as described herein. Memory 420, in some example embodiments, may refer to a non-transitory computer-readable storage medium or a computer-readable storage device. In some examples, memory 420 is a temporary memory, meaning that a primary purpose of memory 420 may not be long-term storage. Memory 420 may also refer to a volatile memory, meaning that memory 420 does not maintain stored contents when memory 420 is not receiving power. Examples of volatile memories include RAM, dynamic random access memories (DRAM), static random access memories (SRAM), and other forms of volatile memories known in the art. In some examples, memory 420 is used to store program instructions for execution by processors 410. Memory 420, in one example, is used by software applications or mobile applications. Generally, software or mobile applications refer to software applications suitable for implementing at least some operations of the methods as described herein.

Data storage 430 can also include one or more transitory or non-transitory computer-readable storage media or computer-readable storage devices. For example, data storage 430 can store instructions for processor 410 to implement the methods described herein. In some embodiments, data storage 430 may be configured to store greater amounts of information than memory 420. Data storage 430 may be also configured for long-term storage of information. In some examples, data storage 430 includes non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

Computing system 400 may also include one or more input devices 440. Input devices 440 may be configured to receive input from a user through tactile, audio, video, or biometric channels. Examples of input devices 440 may include a keyboard, keypad, mouse, trackball, touchscreen, touchpad, microphone, video camera, image sensor, fingerprint sensor, scanner, or any other device capable of detecting an input from a user or other source, and relaying the input to computing system 400 or components thereof.

Output devices 450 may be configured to provide output to a user through visual or auditory channels. Output devices 450 may include a video graphics adapter card, display, such as liquid crystal display (LCD) monitor, light emitting diode (LED) monitor, or organic LED monitor, sound card, speaker, lighting device, projector, or any other device capable of generating output that may be intelligible to a user. Output devices 450 may also include a touchscreen, presence-sensitive display, or other input/output capable displays known in the art.

Computing system 400 can also include network interface 460. Network interface 460 can be utilized to communicate with external devices via one or more communications networks such as communications network 210 or any other wired, wireless, or optical networks. Network interface 460 may be a network interface card, such as an Ethernet card, an optical transceiver, a radio frequency transceiver, or any other type of device that can send and receive information.

An operating system of computing system 400 may control one or more functionalities of computing system 400 or components thereof. For example, the operating system may interact with the software or mobile applications and may facilitate one or more interactions between the software/mobile applications and processors 410, memory 420, data storages 430, input devices 440, output devices 450, and network interface 460. The operating system may interact with or be otherwise coupled to software applications or components thereof. In some embodiments, software applications may be included in the operating system.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A system, comprising:
a database for storing merchandise information;
a sensor for monitoring a temperature of a shipping container;
a monitoring module configured to receive temperature information from the sensor,
determine whether a temperature inside the shipping container and a delivery date for the
container is within a predetermined range; and
a server for maintaining an online dashboard accessible by users, wherein the online dashboard is configured to place or monitor merchandise orders, wherein the server includes:
a database module configured to receive merchandise delivery information, associating ordered merchandise with a delivery location, and store the merchandise delivery information to the database, and
to receive shipping container information, associating the ordered merchandise with the shipping container, and store the merchandise delivery information to the database;
a schedule module configured to, based on the merchandise delivery information and the shipping container information, schedule the shipping container for delivery from a shipping location to the delivery location by at least one carrier;
if it is determined that the temperature inside the shipping container is within the predetermined range, monitor transportation of the shipping container from the shipping location to the delivery location by said at least one carrier and, based at least in part on the monitoring, estimate a first delivery time of the ordered merchandise to the delivery location, wherein the database is updated with the first delivery time of the ordered merchandise; and
if it is determined that the temperature inside the shipping container is not within the predetermined range, initiate a remedial procedure directed to replenish the ordered merchandise at the delivery location and, based at least in part on the remedial measure, estimate a second delivery time of the ordered merchandise to the delivery location, wherein the database is updated with the second delivery time of the ordered merchandise.

2. The system of claim 1, wherein the server is further configured to:
determine an inventory level associated with the merchandise at the delivery location; and
based on the inventory level, re-prioritize delivery of the shipping container from the shipping location to the delivery location.

3. The system of claim 1, wherein the scheduling of the shipping container for delivery is based on at least one rule, wherein the at least one rule is associated with a required delivery date of the ordered merchandise, a planned carrier loading window, and load booking of said at least one carrier.

4. The system of claim 1, wherein the server is further configured to:
generate a model scheduling template associated with said scheduling of the shipping container for delivery from the shipping location to the delivery location by said at least one carrier;
store the model scheduling template in the database; and
invoke the model scheduling template upon receipt of a new merchandise order from the same shipping location to the same delivery location.

5. The system of claim 1, wherein upon the initiation of the remedial procedure, the server is further configured to:
determine whether the temperature inside the shipping container not being within the predetermined range is less or greater than a first predetermined period;
if it is determined that the temperature inside the shipping container not being within the predetermined range is greater than the first predetermined period, search for another shipping container on board of said at least one carrier;
if said another shipping container on board of said at least one carrier is located, prioritize delivery of said another shipping container to the delivery location;
if said another shipping container on board of said at least one carrier is not located, order replacement merchandise, schedule delivery of the replacement merchandise to the delivery location, and estimate a third delivery time of the replacement merchandise to the delivery location, wherein the database is updated with the third delivery time of the replacement merchandise.

6. The system of claim 5, wherein if it is determined that the temperature inside the shipping container not being within the predetermined range is less than the first predetermined period, the server is further configured to determine whether the temperature inside the shipping container not being within the predetermined range is less or greater than a second predetermined period, wherein the second predetermined period is less than the first predetermined period;
if it is determined that the temperature inside the shipping container not being within the predetermined range is less than the second predetermined period, the server is further configured to re-estimate the first delivery time of the ordered merchandise to the delivery location, wherein the database is updated with the first delivery time of the ordered merchandise after said re-estimating; and
if it is determined that the temperature inside the shipping container not being within the predetermined range is greater than the second predetermined period, the server is further configured to identify analogue merchandise at other business location, and initiate transportation of the identified analogue merchandise from said other business location to the delivery location.

7. The method of claim 1, wherein upon said determination of whether the temperature inside the shipping container is within the predetermined range, the server is configured to receive a reading of at least one temperature sensor of said at least one shipping container.

8. A computer-implemented method, the method comprising:
receiving merchandise delivery information, associating ordered merchandise with a delivery location, and storing the merchandise delivery information to a database;
receiving shipping container information, associating the ordered merchandise with at least one shipping container, and storing the merchandise delivery information to the database;
based on the merchandise delivery information and the shipping container information, scheduling said at least one shipping container for delivery from a shipping location to the delivery location by at least one carrier;
determining whether a temperature inside said at least one shipping container is within a predetermined range;
if it is determined that the temperature inside said at least one shipping container is within the predetermined range, monitoring transportation of said at least one shipping container from the shipping location to the delivery location by said at least one carrier and, based at least in part on the monitoring, estimating a first delivery time of the ordered merchandise to the delivery location, wherein the database is updated with the first delivery time of the ordered merchandise; and
if it is determined that the temperature inside said at least one shipping container is not within the predetermined range, initiating a remedial procedure directed to replenish the ordered merchandise at the delivery location and, based at least in part on the remedial measure, estimating a second delivery time of the ordered merchandise to the delivery location, wherein the database is updated with the second delivery time of the ordered merchandise.

9. The method of claim 8, wherein said at least one carrier includes an ocean carrier for transporting said at least one shipping container, wherein said at least one shipping container includes the ordered merchandise.

10. The method of claim 8, wherein the merchandise delivery information further includes a lead time associated with the ordered merchandise and the delivery location.

11. The method of claim 8, further comprising:
sending notifications to a representative of the delivery location and a representative of said at least one carrier to inform scheduling information, wherein the scheduling information is based on said scheduling of said at least one shipping container for delivery from the shipping location to the delivery location by said at least one carrier.

12. The method of claim 8, further comprising:
sending a notification to a representative of the delivery location to inform about the first delivery time or the second delivery time.

13. The method of claim 8, further comprising:
determining an inventory level associated with the merchandise at the delivery location; and
based on the inventory level, re-prioritizing delivery of said at least one shipping container from the shipping location to the delivery location.

14. The method of claim 8, wherein the scheduling of said at least one shipping container for delivery is based on at least one rule, wherein the at least one rule is associated with a required delivery date of the ordered merchandise, a planned carrier loading window, and load booking of said at least one carrier.

15. The method of claim 8, further comprising:
generating a model scheduling template associated with said scheduling of said at least one shipping container for delivery from the shipping location to the delivery location by said at least one carrier;
storing the model scheduling template in the database; and
invoking the model scheduling template upon receipt of a new merchandise order from the same shipping location to the same delivery location.

16. The method of claim 8, wherein the initiating of the remedial procedure further comprising:
determining whether the temperature inside said at least one shipping container not being within the predetermined range is less or greater than a first predetermined period;
if it is determined that the temperature inside said at least one shipping container not being within the predetermined range is greater than the first predetermined period, searching for another shipping container on board of said at least one carrier;
if said another shipping container on board of said at least one carrier is located, prioritizing delivery of said another shipping container to the delivery location;
if said another shipping container on board of said at least one carrier is not located, ordering replacement merchandise, scheduling delivery of the replacement merchandise to the delivery location, and estimating a third delivery time of the replacement merchandise to the delivery location, wherein the database is updated with the third delivery time of the replacement merchandise.

17. The method of claim 16, wherein if it is determined that the temperature inside said at least one shipping container not being within the predetermined range is less than the first predetermined period, determining whether the temperature inside said at least one shipping container not being within the predetermined range is less or greater than a second predetermined period, wherein the second predetermined period is less than the first predetermined period;
if it is determined that the temperature inside said at least one shipping container not being within the predetermined range is less than the second predetermined period, re-estimating the first delivery time of the ordered merchandise to the delivery location, wherein the database is updated with the first delivery time of the ordered merchandise after said re-estimating; and
if it is determined that the temperature inside said at least one shipping container not being within the predetermined range is greater than the second predetermined period, identifying analogue merchandise at other business location, and initiating transportation of the identified analogue merchandise from said other business location to the delivery location.

18. The method of claim 8, wherein said determining of whether the temperature inside said at least one shipping container is within the predetermined range includes receiving a reading of at least one temperature sensor of said at least one shipping container.

19. The method of claim 8, wherein the scheduling of said at least one shipping container comprises generating one or more suggested routes to delivery of said at least one shipping container from the shipping location to the delivery location.

20. A non-transitory processor-readable medium having instructions stored thereon, which when executed by one or more processors, cause the one or more processors to implement a method, the method comprising:
receiving merchandise delivery information, associating ordered merchandise with a delivery location, and storing the merchandise delivery information to a database;
receiving shipping container information, associating the ordered merchandise with at least one shipping container, and storing the merchandise delivery information to the database;
based on the merchandise delivery information and the shipping container information, scheduling said at least one shipping container for delivery from a shipping location to the delivery location by at least one carrier;
determining whether a temperature inside said at least one shipping container is within a predetermined range;
if it is determined that the temperature inside said at least one shipping container is within the predetermined range, monitoring transportation of said at least one shipping container from the shipping location to the delivery location by said at least one carrier and, based at least in part on the monitoring, estimating a first delivery time of the ordered merchandise to the delivery location, wherein the database is updated with the first delivery time of the ordered merchandise; and
if it is determined that the temperature inside said at least one shipping container is not within the predetermined range, initiating a remedial procedure directed to replenish the ordered merchandise at the delivery location and, based at least in part on the remedial measure, estimating a second delivery time of the ordered merchandise to the delivery location, wherein the database is updated with the second delivery time of the ordered merchandise.
